(19) United States
(12) Patent Application Publication
(10) Pub. No.: US 2019/0370688 A1
(43) Pub. Date: Dec. 5, 2019

(54) MACHINE LEARNING FOR ISOLATED DATA SETS

(71) Applicant: JUMIO CORPORATION, Palo Alto, CA (US)

(72) Inventor: Labhesh PATEL, Santa Clara, CA (US)

(21) Appl. No.: 16/428,699

(22) Filed: May 31, 2019

Related U.S. Application Data
(60) Provisional application No. 62/679,697, filed on Jun. 1, 2018.

(51) Int. Cl. G06N 20/00; H04L 29/06

(52) U.S. Cl. CPC G06N 20/00; H04L 63/0876

(57) ABSTRACT

Computer systems and methods are provided for determining an authentication result. A computer system receives a first set of data that corresponds to a first entity. A machine learning system determines a first set of one or more values that correspond to the first set of data. The computer system receives a second set of data that corresponds to a second entity. The machine learning system determines a second set of one or more values that corresponds to the second set of data. The second set of one or more values are determined using at least a portion of the first set of one or more values.

### RELATED APPLICATIONS

This application is a non-provisional application of and claims priority to U.S. provisional application No. 62/679,697, entitled, “Machine Learning for Isolated Data Sets,” filed Jun. 1, 2018, which is herein incorporated by reference in its entirety. Machine learning systems as indicated herein may be as described by U.S. application Ser. No. 15/993,366, filed May 30, 2018, entitled, “Machine Learning for Document Authentication,” which is herein incorporated by reference in its entirety.

### TECHNICAL FIELD

This application relates generally to user authentication, and more particularly, to using machine learning to generate multiple models that correspond to respective isolated data sets.

### BACKGROUND

Collected personally identifiable information (PII) is increasingly subject to regulations (e.g., privacy regulations, such as the General Data Protection Regulation) that place restrictions on use of PII. For example, it may be necessary for PII collected by an entity to be stored separately from PII collected by any other entity. In many cases, systems that generate information use PII collected by multiple different entities. Such systems may not comply with regulations that require isolation of PII collected by an entity.

### SUMMARY

Accordingly, there is a need for systems and/or devices that perform machine learning on isolated data sets. Such systems, devices, and methods optionally complement or replace conventional systems, devices, and methods for applying machine learning to collected data.

The disclosed subject matter includes, in one aspect, a computerized method for receiving a first set of data that corresponds to a first entity. The method also includes determining, using the machine learning system, a first set of one or more values that correspond to the first set of data. The method also includes receiving a second set of data that corresponds to a second entity. The method also includes determining, using the machine learning system, a second set of one or more values that corresponds to the second set of data, wherein the second set of one or more values is determined using at least a portion of the first set of one or more values.

In accordance with some embodiments, a computer readable storage medium stores one or more programs. The one or more programs comprise instructions, which when executed, cause a device to receive a first set of data that corresponds to a first entity. The instructions also cause the device to determine, using the machine learning system, a first set of one or more values that correspond to the first set of data. The instructions also cause the device to receive a second set of data that corresponds to a second entity. The instructions also cause the device to determine, using the machine learning system, a second set of one or more values that corresponds to the second set of data, wherein the second set of one or more values is determined using at least a portion of the first set of one or more values.

In accordance with some embodiments, a system comprises one or more processors, memory, and one or more programs. The one or more programs are stored in the memory and are configured for execution by the one or more processors. The one or more programs include instructions for receiving a first set of data that corresponds to a first entity. The one or more programs also include instructions for determining, using the machine learning system, a first set of one or more values that correspond to the first set of data. The one or more programs also include receiving a second set of data that corresponds to a second entity. The one or more programs also include determining, using the machine learning system, a second set of one or more values that corresponds to the second set of data. The second set of one or more values is determined using at least a portion of the first set of one or more values.

### BRIEF DESCRIPTION OF THE DRAWINGS

So that the present disclosure can be understood in greater detail, features of various embodiments are illustrated in the appended drawings. The appended drawings, however, merely illustrate pertinent features of the present disclosure and are therefore not limiting.

FIG. 1 is a system diagram of a computing system and its context, in accordance with some embodiments.

FIG. 2A is a diagram that illustrates machine learning used to generate a single model that corresponds to multiple data sets, in accordance with some embodiments.

FIG. 2B is a diagram that illustrates machine learning used to generate multiple models that correspond to respective isolated data sets, in accordance with some embodiments.

FIG. 3 illustrates a reference image submitted by a user for authentication, in accordance with some embodiments.

FIG. 4 is a flow diagram that illustrates machine learning used to generate multiple models that correspond to respective isolated data sets, in accordance with some embodiments.

In accordance with common practice, some of the drawings may not depict all of the components of a given system, method, or device. Finally, like reference numerals denote like features throughout the specification and figures.

### DETAILED DESCRIPTION

The systems and methods described herein pertain to machine learning algorithms for determining validity of information that corresponds to an authentication request.

Machine learning systems are used to generate a model (e.g., a set of one or more values and/or algorithms) for analyzing data. A model for authentication of a user may be generated using a set of personally identifiable information (PII). Typically, a model improves as more data is available for generating the model.

Collected PII is increasingly subject to regulations (e.g., privacy regulations, such as the General Data Protection Regulation) that place restrictions on use of PII. For example, it may be necessary for PII collected by an entity to be stored separately from PII collected by any other entity.

A user authentication service that provides authentication information may have access to data sets that include PII collected by multiple entities. In some embodiments, to maintain isolation of a data set (e.g., that includes PII) that corresponds to an entity, a model is generated using the data set of the entity (e.g., without using data from data sets of any other entities). When a model is trained using a data set that includes PII, the resulting model may not include any PII (for example, the resulting model is a set of data including numerical data that corresponds to weights determined by the machine learning system, where none of the numerical data is usable to determine any PII of any user).

To leverage the information generated by machine learning performed on multiple isolated data sets, non-identifying information in a model generated using a first entity's data may be used for generating a model based on a second entity's data. In some embodiments, a set of one or more values (e.g., that include no PII) of a model generated by a machine learning system for a first entity is used for generating a model for a second entity. For example, the set of one or more values in a first model generated using data collected by a first entity are used as initial values for a second model to be generated for the second entity, and the initial values are adjusted as the second model is trained using data set collected by the second entity.

In some embodiments, a generated model is used to analyze information that corresponds to an authentication request. In some embodiments, the authentication request includes an image of an identification document (e.g., that is associated with a user for whom a secure transaction is being performed), such as a passport, driver's license, or workplace identification. In some embodiments, the authentication request includes an image of the user (e.g., a recent “selfie” image). In response to the authentication request, an authentication system determines validity of the image of the identification document and/or compares the image of the user with the image of the identification document to determine whether matching criteria are met. In some embodiments, the information included in an authentication request is used by a machine learning system for generating and/or altering a model that corresponds to a respective entity. In some embodiments, a model that corresponds to a respective entity is used to analyze information included in an authentication request.

In some embodiments, the authentication systems described herein decrease the time required for human review of identification documents (e.g., by using a model generated by a machine learning system to analyze an image and provide information to human reviewers about information generated by the analysis) and/or reduce the extent of human review used for authenticating identification documents (e.g., by using the model to determine whether to bypass human review). Using machine learning as described herein to reduce the extent of human review and/or to reduce the time required for human review improves the authentication device by making the processing of authentication requests faster and more efficient, with less required human interaction, which in turn reduces the processing and power used by an authentication server and/or a validation device.

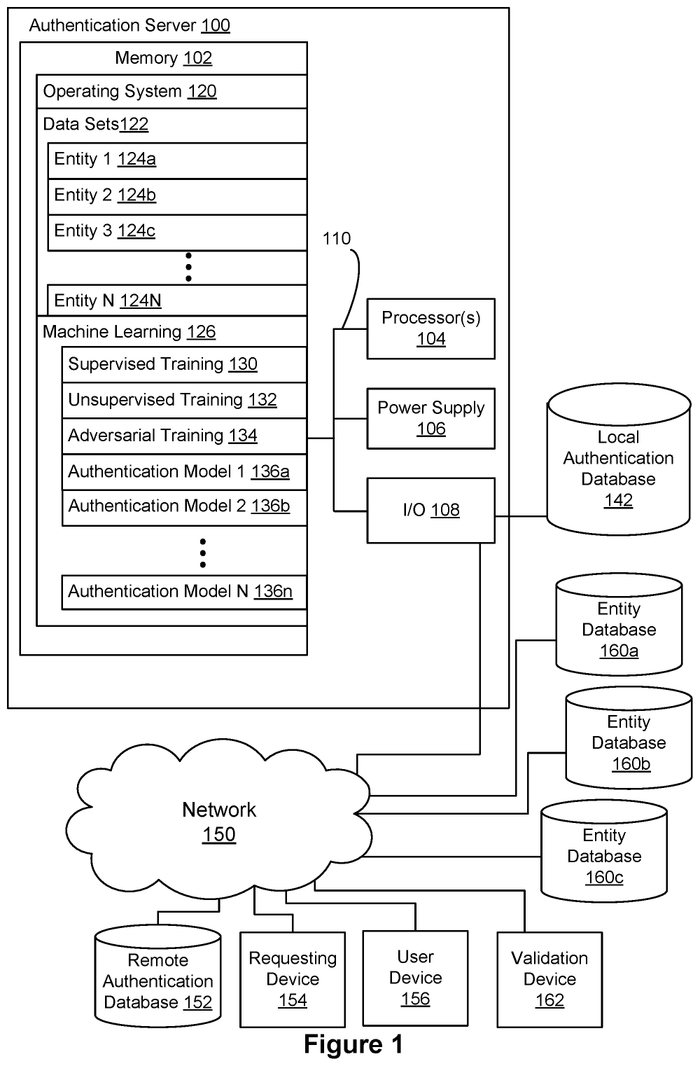

FIG. 1 is a system diagram of an authentication server 100 (also referred to herein as a “machine learning system”), in accordance with some embodiments. The authentication server 100 typically includes a memory 102, one or more processor(s) 104, a power supply 106, an input/output (I/O) subsystem 108, and a communication bus 110 for interconnecting these components.

The processor(s) 104 execute modules, programs, and/or instructions stored in the memory 102 and thereby perform processing operations.

In some embodiments, the memory 102 stores one or more programs (e.g., sets of instructions) and/or data structures, collectively referred to as “modules” herein. In some embodiments, the memory 102, or the non-transitory computer readable storage medium of the memory 102 stores the following programs, modules, and data structures, or a subset or superset thereof:
an operating system 120;
a data sets module 122, which stores information for a plurality of entities 124 (e.g., a first data set for a first entity 124a, a second data set for a second entity 124b, a third data set for a third entity 124c . . . an Nth data set for an Nth entity 124N); and
a machine learning module 126 that uses supervised training module 130, unsupervised training module 132, and/or adversarial training module 134 to generate authentication models 136 (e.g., a first model 136a for a first entity 124a, a second model 136b for a second entity 124b . . . an Nth model 136N for an Nth entity 124N).

The above identified modules (e.g., data structures and/or programs including sets of instructions) need not be implemented as separate software programs, procedures, or modules, and thus various subsets of these modules may be combined or otherwise re-arranged in various embodiments. In some embodiments, the memory 102 stores a subset of the modules identified above. In some embodiments, a remote authentication database 152 and/or a local authentication database 142 store a portion or all of one or more modules identified above. Furthermore, the memory 102 may store additional modules not described above. In some embodiments, the modules stored in the memory 102, or a non-transitory computer readable storage medium of the memory 102, provide instructions for implementing respective operations in the methods described below. In some embodiments, some or all of these modules may be implemented with specialized hardware circuits that subsume part or all of the module functionality. One or more of the above identified elements may be executed by one or more of the processor(s) 104. In some embodiments, machine learning module 126 is stored on, executed by, and/or is distributed across one or more of multiple devices (e.g., authentication server 100, validation device 162 and/or user device 156).

Entity 124 is, for example, an organization (e.g., a merchant or other business that utilizes verification services offered by an entity associated with authentication server 100). In some embodiments, a respective data set of an entity 124 (e.g., a first data set of first entity 124a, a second data set of second entity 124b, and/or a third data set of third entity 124b) is received from an entity database 160 and/or or another entity device communicatively coupled to authentication server 100. In some embodiments, a respective data set of an entity 124 includes personally identifiable information (PII) such as identification information (e.g., unique identification, user name, user password, user residential information, user phone number, user date of birth, and/or user e-mail), a reference image, and/or an authentication image (e.g. image 300). For example, a respective data set of an entity includes PII for one or more users associate with the entity. In some embodiments, access controls (e.g., physical access controls) are used to control access to data sets and/or PII in the data sets. In some embodiments, the data sets are handled in accordance with one or more standards (e.g. the Payment Card Industry Data Security Standard (PCI DSS) standard).

In some embodiments, generating the authentication model 136 includes generating a regression algorithm for prediction of continuous variables.

In some embodiments, the I/O subsystem 108 communicatively couples the computing system 100 to one or more devices, such as a local authentication database 142, a remote authentication database 152, a requesting device 154, a user device 156, a validation device 162 (e.g., including one or more validation servers), and/or one or more entity database(s) 160 (e.g., entity database 160a, entity database 160b, and/or entity database 160c) via a communications network 150 and/or via a wired and/or wireless connection. In some embodiments, the communications network 150 is the Internet.

The communication bus 110 optionally includes circuitry (sometimes called a chipset) that interconnects and controls communications between system components.

In some embodiments, an authentication system for processing authentication requests includes a server computer system 100. In some embodiments, an authentication system for processing authentication requests includes a server computer system 100 that is communicatively connected to one or more validation devices 162 (e.g., via a network 150 and/or an I/O subsystem 108). In some embodiments, the authentication system receives an authentication request (e.g., from a user device 156 that captures an image of a user or from a requesting device 154 that receives an image from user device 156). For example, the authentication request is a request to authenticate the identity of a user (e.g., a user that is a party to a transaction or a user that is requesting access to a system or physical location). Requesting device 154 is, for example, a device of a merchant, bank, transaction processor, computing system or platform, physical access system, or another user.

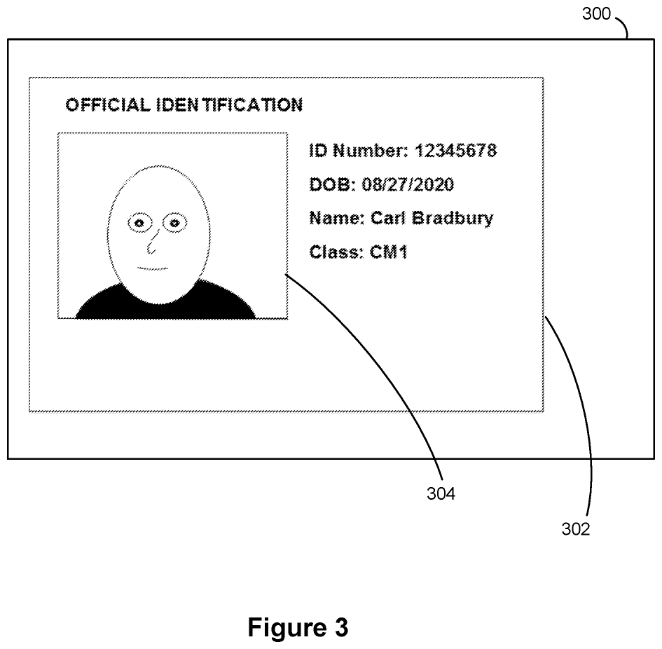

In some embodiments, an authentication request includes an image, such as authentication image 300 illustrated in FIG. 3. For example, authentication image 300 is an image of an identification document for a user. In some embodiments, an authentication request includes a reference image (e.g., an image, series of images, and/or video) of the user captured by a user device 156, such as a recent “selfie” of the user (e.g., in addition to or in lieu of authentication image 300). In some embodiments, an authentication request includes an authentication image 300 and the authentication system locates a reference image that corresponds to the user that provided the authentication image (e.g., a reference image stored in local authentication database 142 and/or remote authentication database 152 by authentication server 100). For example, the authentication system compares image data (e.g., facial image data) and/or data extracted from authentication image 300 with image data (e.g., facial image data) and/or data extracted from the reference image to determine an authentication result that corresponds to the authentication information (e.g., a determination of whether the authentication image is valid, invalid, and/or includes a validation fault). In some embodiments, the authentication system compares image data extracted from authentication image 300 with stored user information (e.g., user information stored in local authentication database 142 and/or remote authentication database 152 by authentication server 100). In some embodiments, authentication server 100 transmits authentication information and/or an authentication result determined using authentication information to requesting device 154 and/or user device 156. In some embodiments, part or all of the PII for a user is extracted from a received authentication image 300.

In some embodiments, the authentication server 100 causes a validation device 162 to display all or a part of a reference image and/or all or a part of an authentication image for human review. In some embodiments, the validation device 162 receives input that corresponds to a determination of whether authentication is successful (e.g., based on whether a fault is detected in an image and/or whether reference image 300 is sufficiently similar to the authentication image 350). In some embodiments, validation device 162 transmits validation information (e.g., to authentication server 100, to requesting device 154, and/or to user device 156) that corresponds to a determination of whether authentication is successful.

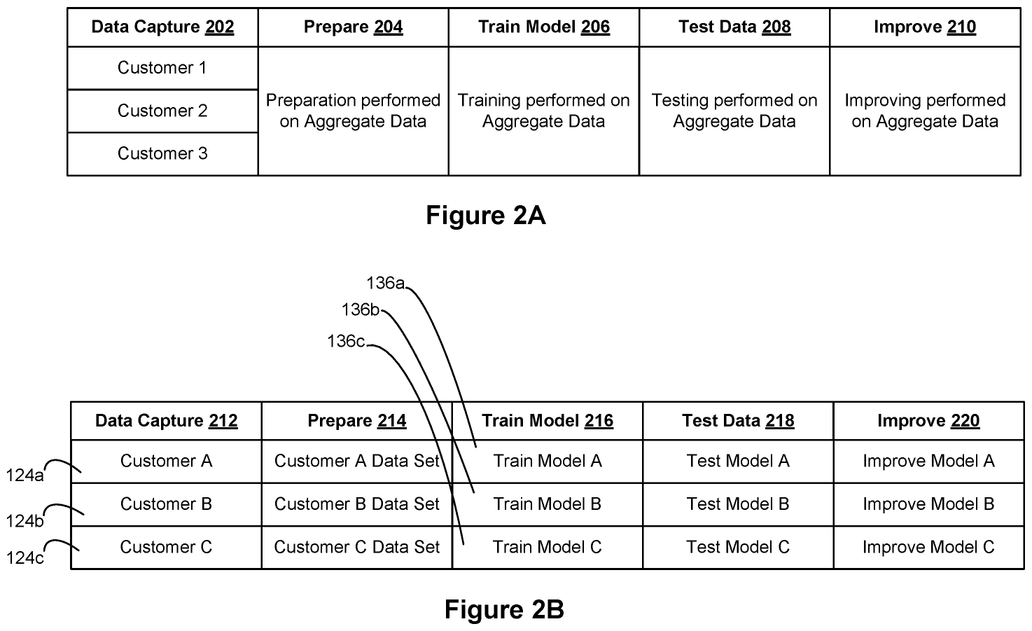

FIG. 2A is a diagram that illustrates machine learning used to generate a single model that corresponds to multiple data sets, in accordance with some embodiments. In data capture phase 202, data sets are obtained from a first customer (“Customer 1”), a second customer (“Customer 2”), and a third customer (“Customer 3”). The data from Customer 1, Customer 2, and Customer 3 is aggregated into a single data set. In preparation phase 204, preparation operations (e.g., removal of data not needed for model generation, reformatting of data, concatenation of data, etc.) are performed on the aggregated data set. In training phase 206, training operations (e.g., providing training data to a machine learning algorithm) are performed on the aggregated data set. In test phase 208, testing operations (e.g., determining the quality of the output of the machine learning algorithm) are performed on the aggregated data set. In improvement phase 210, improvement operations (e.g., applying results of the testing phase to the model) are performed on the aggregated data set. Because machine learning as described with regard to FIG. 2A commingles data from multiple entities to build machine learning models, it may be the case that machine learning as described with FIG. 2A does not comply with a privacy regulation that places restrictions on use of PII.

FIG. 2B is a diagram that illustrates machine learning used to generate multiple models that correspond to respective isolated data sets, in accordance with some embodiments. In some embodiments, machine learning as described with regard to FIG. 2B achieves compliance with one or more privacy regulations by using isolated data sets and/or non-identifying information. In contrast with machine learning performed on an aggregated data set as described with regard to FIG. 2A, machine learning is performed separately for individual data sets in FIG. 2B.

In data capture phase 212, data sets are obtained from a first entity 124a (“Customer A”), a second entity 124b (“Customer B”), and/or a third entity 124c (“Customer C”). In preparation phase 214, first preparation operations (e.g., removal of data not needed for model generation, reformatting of data, concatenation of data, etc.) are performed on the Customer A Data Set of first entity 124a, second preparation operations are performed on the Customer B Data Set of second entity 124b, and/or third preparation operations are performed on the Customer C Data Set of third entity 124c. In training phase 216, first training operations (e.g., providing training data to a machine learning algorithm) are performed on Customer A Data Set of first entity 124a (e.g., to generate authentication model 136a), second training operations are performed on the Customer B Data Set of second entity 124b (e.g., to generate second authentication model 136b), and/or third training operations are performed on the Customer C Data Set of third entity 124c (e.g., to generate authentication model 136c). In some embodiments, a first machine learning algorithm is developed for entity 124a, a second machine learning algorithm is developed for entity 124b, and/or a third machine learning algorithm is developed for entity 124c. In test phase 218, first testing operations (e.g., determining the quality of the output of the machine learning algorithm) are performed on Customer A Data Set of first entity 124a, second testing operations are performed on the Customer B Data Set of second entity 124b, and/or third testing operations are performed on the Customer C Data Set of third entity 124c. In improvement phase 220, first improvement operations (e.g., applying results of the testing phase to the model) are performed on Customer A Data Set of first entity 124a, second improvement operations are performed on the Customer B Data Set of second entity 124b, and/or third improvement operations are performed on the Customer C Data Set of third entity 124c.

FIG. 3 illustrates a reference image 300, in accordance with some embodiments. Reference image 300 is, for example, an image of an identification document 302 that includes a facial image 304 of a user. For example, reference image 300 is an image of an identification card, a driver's license, a passport, a financial instrument (e.g., credit card or debit card), or a facility access card. In some embodiments, at least a portion of the information in a data set is obtained via analysis (e.g., optical character recognition, security feature verification, and/or fault detection) of reference image 300.

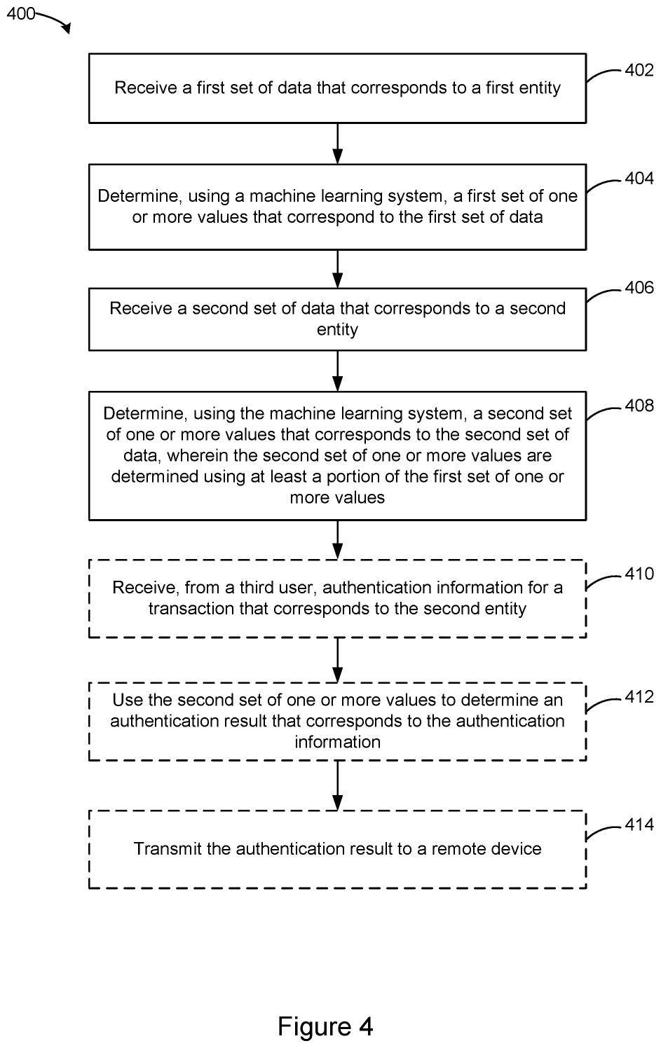

FIG. 4 is a flow diagram illustrating a method 400 for using machine learning to generate multiple models that correspond to respective isolated data sets, in accordance with some embodiments. The method is performed at an authentication server 100, user device 156, and/or a validation device 162. For example, instructions for performing the method are stored in the memory 102 and executed by the processor(s) 104 of the authentication server computer system 100.

The device receives (402) a first set of data that corresponds to a first entity. For example, a first set of data (e.g., Customer A data set) is received by authentication server 100 from an entity database 160a of a first entity 124a (e.g., as described with regard to data capture phase 212 of FIG. 2B). In some embodiments, the device decrypts at least a portion of the first set of data and/or applies encryption to at least a portion of the first set of data.

The device determines (404), using the machine learning system (e.g., machine learning system 126 as described with regard to FIG. 1), a first set of one or more values (e.g., model 136a) that correspond to the first set of data. In some embodiments, the first set of one or more values does not include PII.

In some embodiments, (e.g., prior to determining the first set of one or more values using the machine learning system 126), the device performs one or more preparation operations on the first set of data. For example, the device generates a modified first set of data by removing at least a portion of personally identifiable information from the first set of data (e.g., the machine learning system 126 removes information such as names, phone numbers, and/or addresses from the first data set and determines the first set of one or more values using information such as country, document type, and/or document fault). In some embodiments, the device determines the first set of one or more values using the modified first set of data.

In some embodiments, the first set of data is encrypted while the first set of one or more values that corresponds to the first set of data is determined. For example, the first set of data is encrypted during each epoch (each instance of passage of the first set of data through the first algorithm of authentication model 136a).

The device receives (406) a second set of data that corresponds to a second entity. For example, a second set of data (e.g., Customer B data set) is received by authentication server 100 from an entity database 160b of a second entity 124a (e.g., as described with regard to data capture phase 212 of FIG. 2B). In some embodiments, the device decrypts at least a portion of the second set of data and/or applies encryption to at least a portion of the received second set of data.

The device determines (408), using the machine learning system, a second set of one or more values (e.g., model 136b) that corresponds to the second set of data. The second set of one or more values is determined using at least a portion of the first set of one or more values (e.g., model 136a). For example, insights gained via performing machine learning on the first set of data (e.g., association between risk probabilities and various document types) are used for machine learning performed using the second set of data.

In some embodiments, the first set of data includes personally identifiable information of a first user associated with the first entity (e.g., entity 124a) and the second set of data includes personally identifiable information of a second user associated with the second entity (e.g., entity 124b).

In some embodiments, the second set of data is encrypted while the second set of one or more values that corresponds to the second set of data is determined. For example, the second set of data is encrypted during each epoch (each instance of passage of the second set of data through the second algorithm of authentication model 136b).

In some embodiments, the device receives (410), from a user, authentication information (e.g., an authentication image 300) for a transaction that corresponds to the second entity (e.g., entity 124b).

In some embodiments, the device uses (412) the second set of one or more values (e.g., model 136b) to determine an authentication result that corresponds to the authentication information (e.g., fault detected, match detected, no fault detected, and/or no match detected).

In some embodiments, the device transmits (414) the authentication result to a remote device (e.g., validation device 162, requesting device 154, and/or user device 156).

In some embodiments, the remote device is a validation device 162. In some embodiments, information that corresponds to the authentication result is output (e.g., displayed) by the validation device with a prompt for validation information. In some embodiments, the validation information is received from the validation device.

In some embodiments, the remote device is a user device 156 of the user. In some embodiments, information that corresponds to the authentication result is output (e.g., displayed) by the user device 156.

It should be understood that the particular order in which the operations in FIG. 4 have been described is merely an example and is not intended to indicate that the described order is the only order in which the operations could be performed. One of ordinary skill in the art would recognize various ways to reorder the operations described herein.

Features of the present invention can be implemented in, using, or with the assistance of a computer program product, such as a storage medium (media) or computer readable storage medium (media) having instructions stored thereon/in which can be used to program a processing system to perform any of the features presented herein. The storage medium (e.g., the memory 102) can include, but is not limited to, high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. In some embodiments, the memory 102 include one or more storage devices remotely located from the CPU(s) 104. The memory 102, or alternatively the non-volatile memory device(s) within this memory, comprises a non-transitory computer readable storage medium.

Communication systems as referred to herein (e.g., the communication system 108) optionally communicate via wired and/or wireless communication connections. Communication systems optionally communicate with networks (e.g., the network 150), such as the Internet, also referred to as the World Wide Web (WWW), an intranet and/or a wireless network, such as a cellular telephone network, a wireless local area network (LAN) and/or a metropolitan area network (MAN), and other devices by wireless communication. Wireless communication connections optionally use any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11ac, IEEE 802.11ax, IEEE 802.11b, IEEE 802.11g and/or IEEE 802.11n), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A computer-implemented method, comprising:
at a server system including one or more processors and memory storing one or more programs for execution by the one or more processors:
receiving a first set of data that corresponds to a first entity;
determining, using the machine learning system, a first set of one or more values that correspond to the first set of data;
receiving a second set of data that corresponds to a second entity;
determining, using the machine learning system, a second set of one or more values that correspond to the second set of data, wherein the second set of one or more values is determined using at least a portion of the first set of one or more values.

2. The method of claim 1, wherein the first set of data includes personally identifiable information of a first user associated with the first entity and the second set of data includes personally identifiable information of a second user associated with the second entity.

3. The method of claim 2, including:
receiving, from a third user, authentication information for a transaction that corresponds to the second entity;
using the second set of one or more values to determine an authentication result that corresponds to the authentication information; and
transmitting the authentication result to a remote device.

4. The method of claim 3, wherein the authentication information includes an image of an authentication document.

5. The method of claim 3, wherein the authentication result is a validation fault.

6. The method of claim 3, wherein:
the remote device is a validation device;
information that corresponds to the authentication result is output by the validation device with a prompt for validation information; and
the method includes receiving the validation information from the validation device.

7. The method of claim 3, wherein:
the remote device is a user device of the third user; and
information that corresponds to the authentication result is output by the user device.

8. The method of claim 2 including, prior to determining, using the machine learning system, the first set of one or more values that correspond to the first set of data:
generating a modified first set of data by removing at least a portion of the personally identifiable information of one or more users from the first set of data; and
determining the first set of one or more values using the modified first set of data.

9. The method of claim 1, wherein the first set of data is encrypted while the first set of one or more values that correspond to the first set of data is determined.

10. The method of claim 1, wherein the second set of data is encrypted while the second set of one or more values that correspond to the first set of data is determined.

11. A non-transitory computer readable storage medium storing one or more programs, the one or more programs comprising instructions, which when executed, cause a device to:
receive a first set of data that corresponds to a first entity;
determine, using the machine learning system, a first set of one or more values that correspond to the first set of data;
receive a second set of data that corresponds to a second entity;
determine, using the machine learning system, a second set of one or more values that corresponds to the second set of data, wherein the second set of one or more values is determined using at least a portion of the first set of one or more values.

12. A system, comprising:
one or more processors;
memory; and
one or more programs, wherein the one or more programs are stored in the memory and are configured for execution by the one or more processors, the one or more programs including instructions for:
receiving a first set of data that corresponds to a first entity;
determining, using the machine learning system, a first set of one or more values that correspond to the first set of data;
receiving a second set of data that corresponds to a second entity;
determining, using the machine learning system, a second set of one or more values that corresponds to the second set of data, wherein the second set of one or more values is determined using at least a portion of the first set of one or more values.
